(19) United States
(12) Patent Application Publication
(10) Pub. No.: US 2009/0185968 A1
(43) Pub. Date: Jul. 23, 2009

(54) Application of a metallic anchor layer from a wire feed source to a metallic surface

(76) Inventors: Michael Galligan, (US); Young Kim, (US)

Correspondence Address: BASF CATALYSTS LLC, 100 CAMPUS DRIVE, FLORHAM PARK, NJ, 07932, US

(21) Appl. No.: 12/009,367

(22) Filed: Jan. 18, 2008

(51) Int. Cl. B01D 53/86; B01J 21/06; B01J 21/08; B01J 21/04; B32B 3/12; B01J 23/26

(52) U.S. Cl. 423/219; 502/320; 502/256; 502/313; 502/309; 502/308; 428/116; 502/317

(57) ABSTRACT

The present invention is directed to a catalytic member, and a method of use for the treatment of pollutants in a gaseous stream. More specifically, the present invention is directed to a catalyst member comprising a substrate coated with a metallic anchor layer to enhance the adherence of a catalytic washcoat layer.

### FIELD OF THE INVENTION

The present invention is directed to a catalyst member, and a method of making a catalyst member, for the treatment of pollutants in a gaseous stream. More specifically, the present invention is directed to a catalyst member comprising a substrate coated with a metallic anchor layer to enhance the adherence of a catalytic washcoat layer.

### BACKGROUND OF THE INVENTION

Catalytic converters are well known for the removal and/or conversion of the harmful components of various gas streams. For example, in order to meet governmental emissions standards for internal combustion engine exhaust, motor vehicle manufacturers emplace catalytic converters in the exhaust gas line of their vehicles. A common form of catalytic converter comprises a catalyst member which comprises a honeycomb monolith having gasflow passages extending there-through. The monolith carries a coating of catalytically active material which is effective to convert noxious components of the exhaust gas, which may include unburned hydrocarbons, carbon monoxide and NOx, to innocuous substances. The carrier substrate may comprise ceramic or metallic material.

In another example, a commercial aircraft usually includes an ozone-destroying catalytic converter. Toxic ozone in the compressed air becomes an issue when an aircraft is cruising at altitudes that exceed 20,000 feet. To reduce the ozone to a level within satisfactory limits, such aircraft are provided with an ozone-destroying catalytic converter. A typical ozone-destroying catalytic converter receives compressed air such as bleed air from a compressor stage of an aircraft gas turbine engine, expands the compressed air in a cooling turbine and removes moisture from the compressed air via a water extractor. The ozone-destroying catalytic converter comprises a support substrate, through which compressed air flows, containing a coating of catalytically active material for the abatement of ozone. Optionally, the ozone-destroying catalytic convert may also include catalysts to treat high levels of volatile organic compounds (VOCs), which may also be present in the compressed air.

Commonly, catalytic material is disposed on ceramic substrates by immersing the substrate carrier in a washcoat slurry containing the catalytic material. A similar technology may be used with metallic substrates, but often a catalytic washcoat will not adhere as well to a metallic substrate as it will to a ceramic substrate. Accordingly, there is a need for methods to improve adhesion between metallic substrates and catalytic materials dispersed thereon.

Thermal spraying is a well-established branch of surface coating technology which produces deposits that can add a variety of characteristics and properties to the coated component. It encompasses a number of different methods of spraying which differ in the materials employed and the methods used to melt them.

Essentially, these different methods fall into four basic categories: flame spraying, electric arc spraying, plasma spraying, and detonation spraying. Although these methods differ in the fuels and forms of heating they employ, and also in the nature of the feedstock material, they all retain the basic concept of creating hot particles which are subsequently atomized and projected toward a suitably prepared substrate. Upon striking the target, these hot particles deform with considerable force to produce a lamellar structure.

U.S. Pat. No. 5,204,302, issued Apr. 20, 1993 to I. V. Gorynin et al, is entitled “Catalyst Composition and a Method For Its Preparation” and is hereinbelow referred to as “the '302 Patent”. The '302 Patent discloses a multi-layered catalyst material supported on a metal substrate. The metal substrate (column 4, lines 64-68) may be any thermally stable metal including stainless steel and low alloy steel, the '302 Patent stating that, regardless of which type of substrate is used, there is no appreciable difference in the performance of the bonded layers. As illustrated in FIG. 1 of the Patent and described at column 4, line 32 et seq, a flame spraying or plasma spraying apparatus (FIG. 2 and column 5, line 32 et seq) is used to apply an adhesive sublayer 12 to metal substrate 11, which is shown in solid cross section as a dense (solid) plate-like structure. Adhesive sublayer 12 contains a self-bonding intermetallic compound formed from any one of a number of metal pairings, including aluminum and nickel, as described at column 5, lines 1-6 of the '302 Patent. The high temperature of the flame or plasma spray operation is said to generate a diffusion layer (13 in FIG. 1) caused by diffusion of material of substrate 11 and sublayer 12 across their interface (column 4, lines 37-41). A catalytically active layer 14 (FIG. 1) is sprayed atop the sublayer 12 and has a gradient composition with an increasing content of catalytically active material as one proceeds away from the interface (column 5, lines 7-24). The catalytically active layer can be alumina, preferably gamma-alumina, and may further include specified metal oxide stabilizers such as CaO, Cr₂O₃, etc., and metal oxide catalytic materials such as ZrO₂, Ce₂O₃, etc. A porous layer 18 (FIG. 1 and column 5, lines 25-32) contains some catalytically active components and transition metal oxides as decomposition products of pore forming compounds such as MnCO₃, Na₂CO₃, etc., which presumably form pores as gases evolve from the carbonates or hydroxides (column 7, lines 40-45) as they thermally decompose (see column 7, lines 37-45). As described at column 5, line 44 et seq and at column 7, line 37 et seq, sublayer 12, catalytically active layer 14 and porous layer 18 may be applied by a continuous plasma spray operation in which different ones of the powders 21, 28 and 33 (FIG. 2 of the Patent) are fed into the plasma spray in a preselected sequence and at preselected intervals. An optional activator coating 19 may be applied onto the porous layer, preferably by magnetron sputtering (see column 4, lines 56-63 and column 8, lines 24 et seq).

U.S. Pat. No. 4,027,367, issued Jun. 7, 1977 to H. S. Rondeau, which is incorporated herein by reference, is entitled “Spray Bonding of Nickel Aluminum and Nickel Titanium Alloys” and is hereinbelow referred to as “the '367 Patent”. The '367 Patent discloses a method of electric arc spraying of self-bonding materials, specifically, nickel aluminum alloys or nickel titanium alloys, by feeding metal constituent wires into an electric arc spray gun (column 1, lines 6-13). The '367 Patent mentions, starting at column 1, line 25, combustion flame spray guns, e.g., guns feeding a mixture of oxygen and acetylene to melt a powder fed into the flame. Such combustion flame spray guns are said to operate at relatively low temperature and are often incapable of spraying materials having melting points exceeding 5,000° F. (2,760° C.). The '367 Patent also mentions (starting at column 1, line 32) that plasma arc spray guns are the most expensive type of thermal spray devices and produce much higher temperatures than combustion-type flame spray guns, up to approximately 30,000° F. (16,649° C.). It is further pointed out in the '367 Patent that plasma arc spray guns require a source of inert gas for the creation of plasma as well as extremely accurate control of gas flow rate and electric power for proper operation. In contrast, starting at column 1, line 39, electric arc spray guns are stated to simply require a source of electric power and a supply of compressed air or other gas to atomize and propel the melted material in the arc to the substrate or target. The use of electric arc spraying with a wire feed of nickel aluminum or nickel titanium alloys onto suitable substrates, including smooth steel and aluminum substrates is exemplified starting at column 5, line 28, but no mention is made of open, porous or honeycomb-type substrates, or ceramic substrates and there is no suggestion for the use of the resulting articles as carriers for catalytic materials.

U.S. Pat. No. 4,455,281 to Ishida et al, dated Jun. 19, 1984, discloses a NOx reduction catalyst for the treatment of exhaust gas, in which molten metal is sprayed through a nozzle together with a gas such as compressed air to deposit small droplets of molten metal upon a metal substrate to roughen the substrate surface (see column 4, line 62 through column 5, line 10). The '281 patent only exemplifies the use of various steels as the molten metal. A NOx-reducing catalytic material is coated onto the substrate in the form of a paste or by dipping the metal plate in a slurry of the catalytic substance (see column 5, lines 24 through 30).

U.S. Pat. No. 5,721,188 issued to Sung et al, dated Feb. 24, 1998, discloses a method for applying a coating of catalytic material onto a metallic substrate using a thermal spray deposition of refractory oxide particles directly onto the substrate. A catalytic material is then applied to the refractory oxide coat.

However, these processes are very costly and do not lend themselves easily to the fabrication of alternative catalyst supports such as screens, tubes and wire mesh. Furthermore, prior art catalyst members can have relatively short useful life spans due to spalling of the catalytic material. For example, in utility engine and aircraft applications where greater thermal variation and vibration forces are encountered, spalling is a common problem. Extending the life of these converters by improving the mechanical properties at the interface, and thus, the strong bond between the catalytic material and the substrate, could result in a prolonged life for the catalyst member and thus in significant savings.

It is an object of the present invention to provide a catalyst member with a strong bond between the substrate support and the catalytic material, which is stable to thermal and mechanical shocks typical in utility engine and aircraft applications.

It is a further object of the present invention to provide a catalyst member with improved adhesion between the substrate support and the catalytic material which is more economically beneficial. One key economic benefit of the present invention is the use of less expensive metal feed stocks, such as aluminum and AlCrO, as an anchor layer.

### SUMMARY OF THE INVENTION

The present invention is generally directed to a catalyst member and a method for improved adhesion of a catalyst containing washcoat layer to a support substrate. More specifically, in accordance with the present invention, a catalyst member is provided which comprises a support substrate, onto which an aluminum or AlCrO thermal arc sprayed layer and subsequently a catalytic washcoat are deposited. The thermal arc sprayed layer is an intermetallic layer or anchor layer and holds the refractory oxide or a catalyst containing washcoat layer in place. The catalyst member of the present invention is useful for the treatment of gaseous streams containing pollutants such as hydrocarbons, carbon monoxides, nitrogen oxides, ozone and/or volatile organic compounds.

The present invention is also directed to a method for manufacturing a catalyst member. The method comprising depositing an aluminum or AlCrO anchor layer onto a support substrate by thermal arc spraying (e.g., electric arc spraying) an aluminum or AlCrO metal feedstock onto the substrate support, and subsequently depositing a catalytic washcoat over the anchor layer.

In another embodiment, the present invention provides a method for treating an engine exhaust stream by flowing an exhaust gas stream from an engine through a catalyst member of the present invention.

In yet another embodiment, the present invention provides a method for the abatement of volatile organic compounds (VOCs) and ozone from aircraft cabin air by directing an inlet air stream through a catalyst member prepared in accordance with the present invention.

### BRIEF DESCRIPTION OF THE DRAWINGS

FIG. 1 is a graphic presentation of the conversion of hydrocarbons (HC) and carbon monoxide (CO) in three catalyst members each containing a different intermetallic anchor layer.

### DETAILED DESCRIPTION OF THE INVENTION

The present invention is directed to catalyst members comprising a substrate on which is coated a catalytic material, and to methods of making such catalyzed substrates. More particularly, the present invention relates to catalyzed substrates comprising a substrate which is coated with an aluminum or AlCrO anchor layer in order to enhance the adherence of a catalytic material to the substrate.

In another embodiment, the present invention is directed to a method for the treatment of gaseous streams containing pollutants such as hydrocarbons, carbon monoxides, nitrogen oxides, ozone and/or volatile organic compounds. The method comprising providing a catalyst member in accordance with the present invention and directing a gaseous stream through the catalyst member for the treatment, abatement and/or reduction of pollutants contained therein. In one embodiment, the catalyst member may be used for the treatment of exhaust gas streams from an engine, wherein the catalyst member is used to treat and/or reduce pollutants such as hydrocarbons (HCs), carbon monoxides (COs) and nitrogen oxides (NOx). In another embodiment, the catalyst member may be used for the treatment of an air inlet stream for the preparation of aircraft cabin air, wherein the catalyst member is used for the treatment and/or abatement of ozone and volatile organic compounds (VOCs) contained in the air inlet stream.

The catalyst members prepared in accordance with the present invention can be used in a wide variety of applications in which a fluid stream is flowed through the catalyst member to make contact with the catalytic material therein. An important use for such a catalyst member is as a flow-through catalyst member for the catalytic treatment of the components of a fluid stream, e.g., for the catalytic conversion of the noxious components of engine exhausts including, without limitation, exhausts from internal combustion engines, e.g., spark-ignited gasoline-type engines, such as motorcycle engines, utility engines and the like, and compression-ignited diesel-type engines, etc. Such exhausts may comprise one or more of unburned hydrocarbons, carbon monoxide (CO), oxides of nitrogen (NOx), soluble oil fractions (SOF), soot, etc., which are to be converted by the catalytic material into innocuous substances. For example, the invention may be practiced in exhaust gas recirculation (EGR) lube catalysts for the removal of the SOF from diesel soot. Other applications include catalytic filters for car or aircraft cabin air, reusable home heating air filters, catalytic flame arrestors and municipal catalytic water filtration units.

Catalyst members of this invention are well-suited for use in the treatment of the exhaust of small engines, especially two-stroke and four-stroke engines, because of the superior adherence of the catalytic material to the substrate, and to treat the exhaust of diesel engines. The exhaust gas treatment apparatus associated with a small engine is subjected to significantly different operating conditions from those experienced by the catalytic converters for automobiles or other large engine machines. This is because the devices with which smaller engines are powered are commensurately smaller than those powered by larger engines, e.g., a typical use for a small engine is to drive a lawn mower, whereas a larger engine will power, e.g., an automobile. Small engines are also employed in vehicles such as motorcycles, motor bikes, snow mobiles, jet skis, power boat engines, etc., and as utility engines for chain saws, blowers of snow, grass and leaves, string mowers, lawn edgers, garden tractors, generators, etc. Such smaller devices are less able to absorb and diffuse the vibrations caused by the engine, and they provide less design flexibility with regard to the placement of the catalytic converter. Because of the close proximity of the catalytic converter to a small engine, the catalyst member is subjected to intense vibrations. In addition, although the small mass of the engine allows for rapid cooling of the exhaust gases, small engines are characterized by high temperature variations as the load on the engine increases and decreases. Accordingly, a catalyst member used to treat the exhaust of a small engine is typically subjected to greater thermal variation and more vibration than the catalytic converter on an automobile, and these conditions have lead to spalling of catalytic material from prior art catalyst members. This problem is believed to be heightened in devices for the treatment of motorcycle exhaust because the combustion of fuel in each cycle of a motorcycle engine is believed to generate an explosion that sends a shock wave through the exhaust gas. The shock waves impose periodic stresses on the catalyst member in addition to the heat and vibrations common to other small engines, increasing the need for a strong bond of catalytic material to the substrate and therefore making a catalyst member as provided by this invention especially advantageous.

In another embodiment, a catalyst member may be well-suited for use in the treatment of aircraft cabin air. In this embodiment, the catalyst member comprises one or more catalyst for the treatment and/or abatement of volatile organic compounds (VOCs) and/or ozone from an aircraft air inlet stream. In one embodiment, the catalyst member may comprise a dual-function catalyst for both the reduction of ozone and the removal and/or oxidation of volatile organic compounds (VOCs). In yet another embodiment, the dual-function catalyst comprises separate catalytic chambers, one consisting of a catalyst for the reduction of ozone and the second for the removal and/or oxidation of volatile organic compounds (VOCs). The present invention is also directed to a method of improving aircraft cabin air quality, wherein the method provides an apparatus comprising an air purification system containing a catalyst member or converter for the abatement of VOCs and/or ozone, and directing an inlet air stream through said apparatus.

For abatement catalysts intended for use in aircraft, it is particularly important that the catalyst member be as low weight as possible. It has been found that a highly satisfactory catalyst of lightweight can be made in accordance with the teachings of the present invention by utilizing a metal substrate in which the metal is aluminum or an aluminum alloy such as an aluminum-magnesium alloy. Alternatively, the metal substrate may be made of titanium or a titanium alloy. However, aluminum is lighter than titanium, less expensive and easier to weld or braze in order to form a satisfactory metal substrate. Accordingly, metal substrates made of aluminum or aluminum alloys are, to that degree, preferred. In particular, an aluminum-magnesium alloy provides greater hardness, strength and corrosion resistance than aluminum, but cannot readily be brazed due to the magnesium content. Accordingly, aluminum-magnesium alloy metal substrates would have to rely on pins or other mechanical fasteners to provide a rigid metal substrate structure.

In accordance with the present invention an aluminum or AlCrO metal anchor layer or undercoat is applied directly to one or more surfaces of the support substrate by a thermal spray process. Various suitable thermal spray process are known, including but not limited to, plasma spray, electric arc spray, flame powder spraying, detonation gun spraying, high velocity oxyfuel spraying, etc. In one embodiment, the anchor layer is deposited by electric arc spraying or plasma spraying. The adhesion of the anchor layer and the catalytic washcoat layer to the support substrate provides for a superior adhesion compared to the adhesion of catalytic washcoat layers applied directly to a like substrate by other means, such as by direct application and subsequent drying and calcining.

Thus, the present invention derives from the discovery that thermal spraying aluminum or AlCrO onto a support substrate yields an unexpectedly superior carrier for catalytic materials relative to carriers having metal alloy anchor layers applied thereto by other methods. Catalytic materials have been seen to adhere better to a carrier or substrate comprising an electric arc sprayed anchor layer than to a carrier comprising a substrate without an anchor layer applied thereto. Catalytic materials have also been seen to have better adherence to a carrier or substrate comprising an electric arc sprayed anchor layer than to a carrier comprising a substrate having a metal layer deposited thereon by other methods, e.g., plasma spraying. Before the present invention, catalytic materials disposed on metal substrates, with or without an anchor layer between the substrate and the catalytic material, often did not adhere sufficiently well to the substrate to provide a commercially acceptable product. For example, a metal substrate having a metal anchor layer that was plasma-sprayed thereon and having a catalytic material applied to the anchor layer failed to retain the catalytic material, which flaked off upon routine handling, apparently due to a failure of the anchor layer to bond with the substrate. The catalytic material on other carriers was seen to spall off upon normal use, apparently as a result of being subjected to a high gas flow rate, to thermal cycling, to the eroding contact of high temperature steam and other components of the exhaust gas stream, vibrations, etc. The present invention therefore improves the durability of catalyst members comprising catalytic materials carried on carrier substrates by improving their durability. It also permits the use of such catalyst members in positions upstream from sensitive equipment like turbochargers that would be damaged by catalytic material and/or anchor layer material that spall off prior art catalyst members.

An electric arc spray process can be used to produce an anchor layer on a variety of substrates that may vary by their composition and/or by their physical configuration. For example, the substrate may be an open substrate or a dense substrate; it may be in the form of a metal plate, tube, foil, wire, wire mesh, rigid or malleable foamed metal, etc., ceramic structures, or a combination of two or more thereof. The substrate can typically be a ceramic, plastic or metal substrate. It does not appear to be important to match the sprayed metal to the metal of the substrate.

In most of the applications mentioned above, it may be considered advantageous to provide a carrier of high surface area, i.e., to employ an open substrate, to enhance contact between the fluid stream and the catalyst member. For fluid phase reactions, a suitable carrier typically has a plurality of fluid-flow passages extending therethrough from one face of the carrier to another for fluid-flow therethrough. In one conventional carrier configuration that is commonly used for gas phase reactions and is known as a “honeycomb monolith”, the passages are typically essentially (but not necessarily) straight from an inlet face to an outlet face of the carrier and are defined by walls on which the catalytic material is coated so that the gases flowing through the passages contact the catalytic material. The flow passages of the carrier member may be thin-walled channels which can be of any suitable cross-sectional shape and size such as trapezoidal, rectangular, square, sinusoidal, hexagonal, oval, or circular. Such structures may contain from about 60 to about 700 or more gas inlet openings (“cells”) per square inch of cross section (“cpsi”), more typically 200 to 400 cpsi. Such a honeycomb-type carrier may be constructed from metallic substrates in various ways such as, e.g., by placing a corrugated metal sheet on a flat metal sheet and winding the two sheets together about a mandrel. Alternatively, they may be made of any suitable refractory materials such as cordierite, cordierite-alpha-alumina, silicon nitride, zirconium mullite, spodumene, alumina-silica magnesia, zirconium silicate, sillimanite, magnesium silicates, zirconium oxide, petallite, alpha-alumina and alumino-silicates. Typically, such materials are extruded into a honeycomb configuration and then calcined, thus forming passages defined by smooth interior cell walls and a smooth outer surface or “skin.”

When deposited onto a honeycomb monolith or other flow-through-type carrier, the amounts of the various catalytic components of the catalytic material are often presented based on grams per volume basis, e.g., grams per cubic foot (g/ft³) for platinum group metal components and grams per cubic inch (g/in³) for catalyst member as a whole, as these measures accommodate different gas-flow passage configurations in different carriers. Catalyst members suitable for use in the treatment of engine exhaust gases may comprise a platinum group metal component loading of from about 10 g/ft³ to about 250 g/ft³, although these specifications may be varied considerably according to design and performance requirements. The finished catalyst member may be mounted in a metallic canister that defines a gas inlet and a gas outlet and that facilitates mounting the catalyst member in the exhaust pipe of the engine.

In another embodiment, the surface of the support substrate is roughened before the anchor layer is applied to improve the adhesion between the anchor layer and the support substrate. The inventors have found that the roughness of the support substrate surface to be coated may affect the adhesion of the anchor layer to the support substrate. Roughness can be quantified as a quantity designated Ra, which is defined mathematically as Ra=(1/L)(h₁+h₂+h₃+ . . . hₙ) where hₙ is the absolute value of the height of the surface profile above or below the center line measured at each of a series of n points spaced unit distance apart, and L is the sampling length in those units. Thus, if the height measurements are made in microns, the measurements are made one micron apart over a length of L microns. The center line is drawn such that the sum of the measurements above the line is equal to the sum of those below the line. Roughness can be measured using a profilometer, e.g., a Sutronic 3P profilometer sold by the Taylor-Hobson Company. The effect of roughness on anchor layer adhesion can be seen by comparing the loss of catalytic material from anchor layer coated substrates at different surface roughnesses. Generally, a Ra of at least about 2.5 or higher, e.g., 3, e.g., 4, or higher, provides improved adhesion of the anchor layer onto the support substrate.

Surprisingly, the Applicant has discovered that electric arc spraying, of which wire arc spraying is a particular embodiment, of aluminum or AlCrO onto a metal substrate results in a superior bond between the resulting anchor layer and the substrate relative to plasma spraying. An electric arc sprayed anchor layer is believed to have at least two characteristics that distinguish it from anchor layers applied by plasma spraying: a superior anchor layer-metallic substrate interface bond and a highly irregular or “rough” surface. It is believed that the anchor layer-metallic substrate interface bond may be the result of diffusion between the sprayed material and the metallic substrate that is achieved at their interface despite the relatively low temperature at which wire arc spraying is practiced. For example, the electric arc temperature may be not more than 10,000° F. In such case, the temperature of the molten feedstock is expected to be at a temperature of not more than about 5000° F., preferably in the range of 1000° to 4000° F., more preferably not more than about 2000° F. The low temperature is also believed to be responsible for the especially uneven surface of the anchor layer because the sprayed material cools on the substrate (whether metal or ceramic) to its freezing temperature so quickly that it does not flow significantly on the substrate surface and therefore does not smooth out. Instead, it freezes into an irregular surface configuration. Accordingly, the surface of the anchor layer has a rough profile that provides a superior physical anchor for catalytic components and materials disposed thereon. The rough profile appears to be the result of “pillaring”, the formation of small, pillar-like structures resulting from the sequential deposition and freezing of one molten drop of feedstock material atop another.

One particular aspect of the present invention arises from a discovery that electric arc spraying, e.g., twin wire arc spraying, of aluminum or AlCrO onto a metal or ceramic substrate yields a structure having unexpectedly superior utility as a carrier for catalytic materials in the field of catalyst members, regardless of whether the substrate is an open substrate or a dense substrate. Twin wire arc spraying (encompassed herein by the term “wire arc spraying” and by the broader term “electric arc spraying”) is a known process, as indicated by the above reference to U.S. Pat. No. 4,027,367 which is incorporated herein by reference. Briefly described, in the twin wire arc spray process, two feedstock wires act as two consumable electrodes. These wires are insulated from each other as they are fed to the spray nozzle of a spray gun in a fashion similar to wire flame guns. The wires meet in the center of a gas stream generated in the nozzle. An electric arc is initiated between the wires, and the current flowing through the wires causes their tips to melt. A compressed atomizing gas, usually air, is directed through the nozzle and across the arc zone, shearing off the molten droplets to form a spray that is propelled onto the substrate. Only metal wire feedstock can be used in an arc spray system because the feedstock must be conductive. The high particle temperatures created by the spray gun produce minute weld zones at the impact point on a metallic substrate. As a result, such electric arc spray coatings (sometimes referred to herein as “anchor layers”) have good cohesive strength and a very good adhesive bond to the substrate.

The principal operating parameters in wire arc spraying include the voltage and amperage for the arc, the compression of the atomizing gas, the nozzle configuration and the stand-off from the substrate. The voltage is generally in the range of from 18 to 40 volts, and is typically in the range of from 28 to 32 volts; the current may be in the range of from about 100 to 400 amps. The atomizing gas may be compressed to a pressure in the range of from about 30 to 70 psi. The nozzle configuration (e.g., slot aperture or cross aperture) and spray pattern vary in accordance with the desired nature of the anchor layer or may be chosen to accommodate the other parameters or the character of the substrate. A suitable stand-off is generally in the range of from about 4 to 10 inches from the substrate to the nozzle. Another operating parameter is the spray rate for the feedstock, a typical example of which would be 100 pounds per hour per 100 amps (4.5 kg/hr/100 amps). Still another parameter is the coverage or feedstock consumption rate, which may be, to give a particular example, 0.9 ounce per square foot per 0.001 inch thickness of the anchor layer. (It is typical to have a deposition efficiency of 70 percent (e.g., for spraying a plate) or less.) Electric arc spray coatings are usually harder to finish (e.g., to grind down) and normally have higher spray rates than coatings of other thermal spray processes. In one embodiment of the present invention aluminum or AlCrO electrode wires are used to create an aluminum or AlCrO anchor layer. However, dissimilar electrode wires can also be used to create an anchor layer containing a mixture of two or more different metal materials, referred to as a “pseudoalloy”. Optionally, reactive gases can be used to atomize the molten feedstock to effect changes in the composition or properties of the applied anchor layer. On the other hand, it may be advantageous to employ an inert gas or at least a gas that does not contain oxygen or another oxidizing species. Oxygen, for example, may cause oxidation on the surface of a metal substrate or in the feedstock material and thus weaken the bond between the anchor layer and the substrate.

As used herein “aluminum” can mean pure aluminum, or an aluminum alloy containing at least 75% by weight, at least 90% by weight, or at least 95% by weight aluminum. The aluminum feedstock may contain minor proportions of other metals referred to herein as “impurities” totaling not more than about 2% by weight of the aluminum feedstock. Some such impurities may be included in the aluminum feedstock for various purposes, e.g., as processing aids to facilitate the wire arc spraying process or the formation of the anchor layer, or to provide the anchor layer with favorable properties. As used herein “AlCrO” can be any known AlCrO metal. For example, the AlCrO metal can comprise from about 5% by weight to about 95% by weight Al, and from about 10% by weight to about 20% by weight Cr. In another embodiment, the AlCrO metal can comprise from about 50% by weight to about 95% by weight Al and from about 10% by weight to about 20% by weight Cr.

The strong bond of an anchor layer achieved by electric arc spraying may permit the resulting substrates to be mechanically processed in various ways that reshape the substrate but that do not diminish the mass of the substrate, i.e., they do not involve cutting, grinding or other removal of substrate material. For example, pliable (i.e., malleable and/or flexible) anchor layer-coated substrates may be bent, compressed, folded, rolled, woven, etc., after the anchor layer is deposited thereon, in addition to or instead of being cut, ground, etc. As used herein and in the claims, the term “reshape” is meant to encompass all such processes that deform the substrate but do not reduce its mass by cutting, grinding, etc. Thus, a wire arc-sprayed foil substrate can be reshaped by being corrugated and rolled with a flat foil to provide a corrugated foil honeycomb. A wire can be reshaped by being sprayed and then woven with other wires to compose a mesh that is used as a carrier for a catalytic material. Similarly, a flat wire mesh substrate that has been wire arc sprayed in accordance with this invention can then be reshaped by being curled into a cylindrical configuration or by being formed into a corrugated sheet that may optionally be combined with other substrates to compose a carrier, or that may be used on its own. Likewise, foamed metal having an anchor layer thereon may be reshaped by being compressed to change its shape and/or density as discussed herein. Such reshaping may occur before or even after catalytic material is deposited on the foamed metal substrate. The present invention permits the manufacture of carriers and/or catalyst members that can easily be molded to fit within a portion of an exhaust gas treatment apparatus that serves as a container for the catalyst member, e.g., in a canister specifically designed to house a catalyst member, or in another portion of the apparatus, e.g., an exhaust manifold, exhaust flow pipe, a high mass transfer area conduit, etc. For example, a flat, catalyzed wire mesh patch prepared in accordance with the spraying and coating methods described herein may be reshaped for installation in an exhaust pipe by being rolled into a coiled configuration. Optionally, the substrate may be resilient and may, upon insertion into a containing structure, be allowed to unwind or otherwise relax from the reshaping force to the extent that it bears against the interior surface of the containing structure, thus conforming to the structure.

An anchor layer deposited on a substrate as taught herein can provide some rigidity to an excessively ductile or malleable metal substrate, it can provide a roughened surface on which a catalytic material may be deposited, and it can seal the surface of a metal substrate and thus protect the substrate against surface oxidation during use. As mentioned above, the ability to tenaciously adhere a catalytic material to a metal substrate as provided herein may also permit structural modification of a catalyst member as required to conform to the physical constraints imposed by canisters or other features of the exhaust gas treatment apparatus in which the catalyst member is mounted, without significant loss of catalytic material therefrom.

A suitable catalytic material for use on a carrier substrate prepared in accordance with this invention can be prepared by dispersing a compound and/or complex of any catalytically active component, e.g., one or more precious metal compounds or component, onto relatively inert bulk support material. As used herein, the term “compound”, as in “precious metal compound” means any compound, complex, or the like of a catalytically active component (or “catalytic component”) which, upon calcination or upon use of the catalyst, decomposes or otherwise converts to a catalytically active form, which is often, but not necessarily, an oxide. The precious metal component or catalytic component of the present invention comprises one or more precious metals selected from the group consisting of gold, silver and platinum group metals. As used herein, the term “platinum group metals” means platinum, rhodium, palladium, ruthenium, iridium, and osmium. The precious metal component of the present invention may also include gold, silver or platinum group metal compound, complex, or the like which, upon calcination or use of the catalyst decomposes or otherwise converts to a catalytically active form, usually, the metal or the metal oxide. The compounds or components of one or more catalytic components may be dissolved or suspended in any liquid which will wet or impregnate the support material, which does not adversely react with other components of the catalytic material and which is capable of being removed from the catalyst by volatilization or decomposition upon heating and/or the application of a vacuum. Generally, both from the point of view of economics and environmental aspects, aqueous solutions of soluble compounds or components are preferred. For example, suitable water-soluble platinum group metal compounds are chloroplatinic acid, amine solubilized platinum hydroxide, rhodium chloride, rhodium nitrate, hexamine rhodium chloride, palladium nitrate or palladium chloride, etc. The compound-containing liquid is impregnated into the pores of the bulk support particles of the catalyst, and the impregnated material is dried and preferably calcined to remove the liquid and bind the platinum group metal into the support material. In some cases, the completion of removal of the liquid (which may be present as, e.g., water of crystallization) may not occur until the catalyst is placed into use and subjected to the high temperature exhaust gas. During the calcination step, or at least during the initial phase of use of the catalyst, such compounds are converted into a catalytically active form of the platinum group metal or a compound thereof. An analogous approach can be taken to incorporate the other components into the catalytic material. Optionally, the inert support materials may be omitted and the catalytic material may consist essentially of the catalytic component deposited directly on the sprayed carrier substrate by conventional methods.

Suitable support materials for the catalytic component include alumina, silica, titania, silica-alumina, alumino-silicates, aluminum-zirconium oxide, aluminum-chromium oxide, etc. Such materials are preferably used in their high surface area forms. For example, gamma-alumina is preferred over alpha-alumina. It is known to stabilize high surface area support materials by impregnating the material with a stabilizer species. For example, gamma-alumina can be stabilized against thermal degradation by impregnating the material with a solution of a cerium compound and then calcining the impregnated material to remove the solvent and convert the cerium compound to a cerium oxide. The stabilizing species may be present in an amount of from about, e.g., 5 percent by weight of the support material. The catalytic materials are typically used in particulate form with particles in the micron-sized range, e.g., 10 to 20 microns in diameter, so that they can be formed into a slurry and coated onto a carrier member.

A typical catalytic material for use on a catalyst member for a small engine comprises platinum, palladium and rhodium dispersed on an alumina and further comprises oxides of neodymium, strontium, lanthanum, barium and zirconium. Some suitable catalysts are described in U.S. patent application Ser. No. 08/761,544 filed Dec. 6, 1996, the disclosure of which is incorporated herein by reference. In one embodiment described therein, a catalytic material comprises a first refractory component and at least one first platinum group component, preferably a first palladium component and optionally, at least one first platinum group metal component other than palladium, an oxygen storage component which is preferably in intimate contact with the platinum group metal component in the first layer. An oxygen storage component (“OSC”) effectively absorbs excess oxygen during periods of lean engine operation and releases oxygen during periods of fuel-rich engine operation and thus ameliorates the variations in the oxygen/hydrocarbon stoichiometry of the exhaust gas stream due to changes in engine operation between a fuel-rich operation mode and a lean (i.e., excess oxygen) operation mode. Bulk ceria is known for use as a OSC, but other rare earth oxides may be used as well. In addition, as indicated above, a co-formed rare earth oxide-zirconia may be employed as a OSC. The co-formed rare earth oxide-zirconia may be made by any suitable technique such as co-precipitation, co-gelling or the like. One suitable technique for making a co-formed ceria-zirconia material is illustrated in the article by Luccini, E., Mariani, S., and Sbaizero, O. (1989) “Preparation of Zirconia Cerium Carbonate in Water With Urea” Int. J. of Materials and Product Technology, vol. 4, no. 2, pp. 167-175, the disclosure of which is incorporated herein by reference. As disclosed starting at page 169 of the article, a dilute (0.1M) distilled water solution of zirconyl chloride and cerium nitrate in proportions to promote a final product of ZrO₂-10 mol % CeO₂ is prepared with ammonium nitrate as a buffer, to control pH. The solution was boiled with constant stirring for two hours and complete precipitation was attained with the pH not exceeding 6.5 at any stage.

Any suitable technique for preparing the co-formed rare earth oxide-zirconia may be employed, provided that the resultant product contains the rare earth oxide dispersed substantially throughout the entire zirconia matrix in the finished product, and not merely on the surface of the zirconia particles or only within a surface layer, thereby leaving a substantial core of the zirconia matrix without rare earth oxide dispersed therein. Thus, co-precipitated zirconium and cerium (or one other rare earth metal) salts may include chlorides, sulfates, nitrates, acetates, etc. The co-precipitates may, after washing, be spray dried or freeze dried to remove water and then calcined in air at about 500° C. to form the co-formed rare earth oxide-zirconia support. The catalytic materials of aforesaid application Ser. No. 08/761,544 may also include a first zirconium component, at least one first alkaline earth metal component, and at least one first rare earth metal component selected from the group consisting of lanthanum metal components and neodymium metal components. The catalytic material may also contain at least one alkaline earth metal component and at least one rare earth component and, optionally, at least one additional platinum group metal component preferably selected from the group consisting of platinum, rhodium, ruthenium, and iridium components with preferred additional first layer platinum group metal components being selected from the group consisting of platinum and rhodium and mixtures thereof.

In another embodiment of the present invention, the catalyst may be an ozone-destroying catalyst or an ozone abatement catalyst. The ozone-destroying catalyst of the present invention contains one or more catalysts for the abatement of ozone, and optionally for the abatement of volatile organic compounds (VOCs), for improving cabin air quality, particularly in aircraft. The ozone abatement catalyst useful for the practice of the present invention can be any ozone abatement catalyst known in the art. For example, the ozone abatement catalysts of U.S. Pat. Nos. 4,343,776; 4,206,083; 4,900,712; 5,080,882; 5,187,137; 5,250,489; 5,422,331; 5,620,672; 6,214,303; 6,340,066; and 6,616,903, which are hereby incorporated by reference, are useful for the practice of the present invention.

An illustrative example is U.S. Pat. No. 6,616,903, which discloses a useful ozone treating catalyst comprises at least one precious metal component, preferably a palladium component dispersed on a suitable support such as a refractory oxide support. The composition comprises from 0.1 to 20.0 weight %, and preferably 0.5 to 15 weight % of precious metal on the support, such as a refractory oxide support, based on the weight of the precious metal (metal and not oxide) and the support. Palladium is preferably used in amounts of from 2 to 15, more preferably 5 to 15 and yet more preferably 8 to 12 weight %. Platinum is preferably used at 0.1 to 10, more preferably 0.1 to 5.0, and yet more preferably 2 to 5 weight %. Palladium is most preferred to catalyze the reaction of ozone to form oxygen. The support materials can be selected from the group recited above. In one embodiment, there can additionally be a bulk manganese component, or a manganese component dispersed on the same or different refractory oxide support as the precious metal, preferably palladium component. There can be up to 80, preferably up to 50, more preferably from 1 to 40 and yet more preferably 5 to 35 weight % of a manganese component based on the weight of palladium and manganese metal in the pollutant treating composition. Stated another way, there is preferably about 2 to 30 and preferably 2 to 10 weight % of a manganese component. The catalyst loading is from 20 to 250 grams and preferably about 50 to 250 grams of palladium per cubic foot (g/ft³) of catalyst volume. The catalyst volume is the total volume of the finished catalyst composition and therefore includes the total volume of air conditioner condenser or radiator including void spaces provided by the gas flow passages. Generally, the higher loading of palladium results in a greater ozone conversion, i.e., a greater percentage of ozone decomposition in the treated air stream.

Another illustrative example from U.S. Pat. No. 6,616,903, comprises a catalyst compositions to treat ozone comprising a manganese dioxide component and precious metal components such as platinum group metal components. While both components are catalytically active, the manganese dioxide can also support the precious metal component. The platinum group metal component preferably is a palladium and/or platinum component. The amount of platinum group metal compound preferably ranges from about 0.1 to about 10 weight % (based on the weight of the platinum group metal) of the composition. Preferably, where platinum is present it is in amounts of from 0.1 to 5 weight %, with useful and preferred amounts on pollutant treating catalyst volume, based on the volume of the supporting article, ranging from about 0.5 to about 70 g/ft³. The amount of palladium component preferably ranges from about 2 to about 10 weight % of the composition, with useful and preferred amounts on pollutant treating catalyst volume ranging from about 10 to about 250 g/ft³.

Ozone abatement catalysts, especially those containing a palladium catalytic component, are effective at temperatures as low as about 100° F. (37.7° C.), although the rate of ozone abatement is increased if the air or other gas stream being treated is heated to a higher temperature. Nonetheless, in some applications it is highly desirable to have the catalyst composition be effective over a broad range of inlet gas temperatures, on the order of about 100° to 300° F. (21.1° to 148.9° C.). For effective low temperature operation it is desirable that a high density of the noble catalytic metal, such as palladium, be attained in highly dispersed form on the refractory metal oxide support. It has been found that the desired high density of palladium catalytic component is enhanced if the soluble palladium salt used to impregnate the overlayer refractory metal oxide particles is a solution of a palladium amine salt, such as palladium tetraamine hydroxide or palladium tetraamine acetate, or palladium nitrate. The use of such salts, especially in combination with a high porosity refractory metal oxide support as described below is found to give higher densities of palladium with improved dispersion on the overlayer refractory metal oxide than that attainable under similar conditions with other palladium salts, such as palladium acetate or palladium chloride. Of course, as noted above, palladium chloride is preferably not used in any case in order to render the catalyst composition a non-chloride composition and thereby ameliorate or prevent corrosion of metal substrates on which the catalyst composition is carried.

Optionally, the ozone-destroying or ozone abatement catalyst member may also contain a volatile organic compound (VOC) abatement catalysts. Any known volatile organic compound (VOC) abatement catalyst may be useful for the practice of the present invention. For example, the VOC abatement systems of U.S. Pat. Nos. 3,972,979; 4,053,557, 4,059,675; 4,059,676; 4,059,683; 5,283,041, 5,643,545; 5,578,283; 5,653,949; and 6,319,484, which are hereby incorporated by reference, are useful for the practice of the present invention. The abatement composition adsorbs and/or oxidizes volatile organic compounds, such as hydrocarbons, aldehydes, ketones, etc., in alternating adsorption and oxidation temperature ranges which lie within a low to moderate operating temperature range.

An illustrative example is U.S. Pat. No. 6,616,903, which discloses a catalyst composition to treat volatile organic compounds (VOCs), can comprise from 0.01 weight % to 20 weight % and preferably 0.5 weight % to 15 weight % of the precious metal component on a suitable support such as a refractory oxide support, with the amount of precious metal being based on the weight of the precious metal, (not the metal component) and the support. Platinum is the most preferred and is preferably used in amounts of from 0.01 weight % to 10 weight % and more preferably 0.1 weight % to 5 weight % and most preferably 1.0 weight % to 5 weight %. When loaded onto a monolithic structure the catalyst loading is preferably about 1 to 150, and more preferably 10 to 100 grams of platinum per cubic foot (g/ft³) of catalyst volume. The preferred refractory oxide support is a metal oxide refractory which is preferably selected from ceria, silica, zirconia, alumina, titania and mixtures thereof with alumina and titania being most preferred.

### EXAMPLE

Three separate heat tubes were prepared containing an anchor layer bond coating of 200 g/m² NiAl, 200 g/m² AlCrO and 200 g/m² Al, respectfully. The bond layers were first deposited by electric arc spraying and subsequently coated with platinum group metal component loading of 35 g/ft³ with a weight ratio of platinum-to-rhodium of 5:1, as a catalyst washcoat. The heat tubes were then aged at 850° C. for 7.5 hours and evaluated with a 2.3L I4 Ford engine using MVEG_MC (Euro III Motorcycle test cycle (including cold start). Emissions were collected and measured as a percentage of hydrocarbon (HC) and/or carbon monoxide (CO) converted.

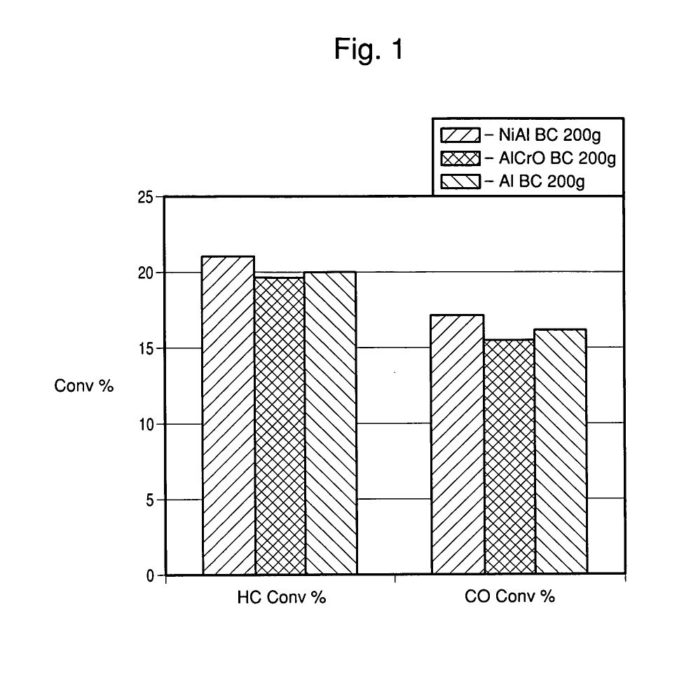

The study indicated that bond coating material does not significantly alter the catalytic ability of the catalyst member. See FIG. 1.

1.-10. (canceled)

11. A catalyst member comprising:
(a) a support substrate;
(b) an aluminum anchor layer coated onto said substrate; and
(c) a catalyst layer coated over said aluminum anchor layer,
wherein said aluminum anchor layer comprises at least 90% by weight aluminum.

12. The catalyst member of claim 11, wherein said aluminum anchor layer is deposited by thermal arc spraying.

13. The catalyst member of claim 11, wherein said aluminum anchor layer is deposited by electric arc spraying.

14. The catalyst member of claim 11, wherein said support substrate is a ceramic, plastic or metal substrate.

15. The catalyst member of claim 11, wherein said catalyst is deposited on said anchor layer as a washcoat comprising a refractory oxide support and one or more precious metal compounds.

16. A method of treating an air inlet stream for the preparation of aircraft cabin air, wherein a catalyst member is used for the treatment and/or abatement of ozone and/or volatile organic compounds (VOCs) contained in said air inlet stream, said method comprising directing a gaseous stream containing said ozone and/or volatile organic compounds (VOCs) through a catalyst member for the treatment and/or abatement thereof, wherein said catalyst member comprises:
(i) a support substrate;
(ii) an aluminum or AlCrO metal anchor layer coated onto at least one surface of said support substrate;
(iii) a catalyst washcoat layer coated over said aluminum or AlCrO metal anchor layer, wherein said catalyst washcoat layer contains one or more catalysts for the reduction and/or abatement of ozone and/or volatile organic compounds (VOCs); and
(iv) directing said treated air inlet stream into said aircraft cabin.

17. The method of claim 16, wherein said aluminum or AlCrO metal anchor layer is deposited on said support substrate by thermal arc spraying an aluminum or AlCrO metal feedstock onto said support substrate.

18. The method of claim 16, wherein said aluminum or AlCrO metal anchor layer is deposited on said support substrate by electric arc spraying an aluminum or AlCrO metal feedstock onto said support substrate.

19. The method of claim 16, wherein said support substrate is a ceramic, plastic or metal substrate.

20. The method of claim 19, wherein said metal substrate is selected from the group consisting of aluminum, aluminum alloy, titanium and titanium alloy.

21. The catalyst member of claim 15, wherein said refractory oxide is selected from the group consisting of alumina, silica, titania, silica-alumina, aluminosilicates, aluminum-zirconium oxide, and aluminum-chromium oxide.

22. The catalyst member of claim 11, wherein said aluminum anchor layer comprises at least 95% by weight aluminum.

23. The catalyst member of claim 22, wherein said aluminum anchor layer comprises pure aluminum.

24. The catalyst member of claim 11, wherein the support substrate is a honeycomb monolith.
